(19) United States
(12) Patent Application Publication
(10) Pub. No.: US 2021/0214811 A1
(43) Pub. Date: Jul. 15, 2021

(54) METAL-FREE TANNING METHOD

(71) Applicant: Santori Pellami S.P.A., Monte Urano (FM) (IT)

(72) Inventors: Andrea Santori, Monte Urano (FM) (IT); Sara Santori, Monte Urano (FM) (IT)

(73) Assignee: Santori Pellami S.P.A, Monte Urano (FM) (IT)

(21) Appl. No.: 17/271,073

(22) PCT Filed: Aug. 28, 2019
(86) PCT No.: PCT/IB2019/057231

§ 371 Date: Feb. 24, 2021

(30) Foreign Application Priority Data
Aug. 30, 2018 (IT) 102018000008252

(51) Int. Cl. C14C 3/16; C14C 3/28; C14C 1/08; C14C 3/30; D06P 3/32

(52) U.S. Cl. CPC C14C 3/16; C14C 3/28; C14C 15/00; C14C 3/30; D06P 3/32; C14C 1/08

(57) ABSTRACT

Method (1) for metal-free tanning of a quantity of hide having initial weight (w), said quantity of hide being contained in a drum, wherein said method (1) comprises at least one tanning treatment (B) of said hide including at least the following operating steps: B.1 feeding aliphatic aldehyde into said drum, in a percentage ranging between about 1% and 3% by weight with respect to the initial weight (w) of said hide, optionally equal to about 2% by weight, and B.2 moving said drum for a time period of at least about 10 min, optionally approximately 20 min at an operating speed between 1 and 8 revolutions/minute, preferably comprised between 4 and 5 revolutions/minute; B.3 feeding citric acid into said drum, in a percentage ranging between about 0.1% and 0.3% by weight with respect to the initial weight (w) of said hide, optionally equal to about 0.2% by weight, and B.4 moving said drum for a time period of at least about other 10 min, optionally approximately 20 min at said operating speed; B.5 feeding aliphatic aldehyde into said drum, in a percentage ranging between about 1% and about 3% by weight with respect to the initial weight (w) of said hide, optionally equal to about 2% by weight, and B.6 moving said drum for a time period of at least about 150 min, optionally approximately 180 min at said operating speed; B.7 feeding sodium formate into said drum, in a percentage ranging between about 0.3% and about 0.7% by weight with respect to the initial weight (w) of said hide, optionally equal to about 0.5% by weight, and B.8 moving said drum for a time period of at least about 20 min, optionally approximately 30 min at said operating speed; B.9 feeding magnesium oxide into said drum, in a percentage ranging between about 0.3% and about 0.7% by weight with respect to the initial weight (w) of said hide, optionally equal to about 0.5% by weight, and B.10 moving said drum for a time period of at least about 60 min, optionally approximately 90 min at said operating speed; B.11 feeding water into said drum, at a temperature ranging between about 30° C. and about 60° C., optionally equal to about 50° C., in a percentage ranging between about 30% and 50% by weight with respect to the initial weight (w) of said hide, optionally equal to about 40% by weight, and B.12 moving said drum for a time period of at least about 100 min, optionally approximately 120 min at said operating speed; B.13 feeding aliphatic aldehyde into said drum, in a percentage ranging between about 1% and 5% by weight with respect to the initial weight (w) of said hide, optionally equal to about 3% by weight, and B.14 moving said drum for a time period of at least about 100 min, optionally approximately 120 min at said operating speed; and then B.15 moving said drum for a maintaining period comprised between about 10 and about 16 hours, optionally approximately 14 hours, at a first maintaining speed ranging between about 1 and 5 revolutions/hour, optionally comprised between 2 and 4 revolutions/hour, even more optionally equal to about 3 revolutions/hour.

The present invention relates to an improved method for the tanning of hide. More particularly, it relates to a so-called metal-free tanning method, i.e. a tanning method that does not comprise the use of heavy metals, among which chromium.

The present invention also relates to a tanning method capable of producing a tanned hide that can be disposed of more easily with respect to traditional methods, being it biodegradable.

As is known, the tanning of hide is a method to which hides are subjected, in order to preserve them and make them workable, for example for the production of items of clothing and leather goods.

Such method comprises, in general:
one or more preliminary treatments of hide preparation, also called pre-tanning treatments, during which the hide is mechanically and chemically treated to lower its pH from a value usually equal to about 10-12 to a value equal to about 3-4, in order to make it better able to absorb the tanning agents;
one regular tanning treatment, during which hide is chemically and mechanically treated and made rot-proof; and
one or more treatments following the tanning one, also called post-tanning treatments, during which the tanned hide is chemically and mechanically treated to make it suitable for use in the manufacturing of articles of various kinds, including those indicated above.

In the state of the art the more widespread type of tanning is certainly chromium tanning. It is a tanning method that in the regular tanning step takes advantage of the capacity of trivalent chromium (Cr³⁺) to form complexes with the carboxylic groups of collagen which makes up the hide fibres. This type of tanning is relatively easy to carry out, economical and fast. Accordingly, it is widely diffused.

Alternative tanning methods exist which, instead of chromium, exploit other minerals such as aluminium, zirconium, titanium, etc. for hide treatment.

In any case, all types of tanning employing heavy metals suffer from some important disadvantages linked both to the environmental pollution caused by the presence of high quantities of chemical products (such as, for example, trivalent chromium in the chromium tanning) in wastewater from treatment plants, which therefore require special depurative processes, and to the fact that in the hide which is tanned with these traditional methods residues of metals and other allergenic substances remain, with the consequent increase in allergies for those wearing/using products made therewith.

Among other things, the hide tanned with traditional methods, containing precisely metals and allergenic substances, must be disposed of according to special disposal processes, because it is polluting.

One tanning method, alternative to the ones mentioned above is the so-called aldehyde tanning. It is a tanning method that is more ancient than chromium tanning, which envisages the use of aldehydes, usually of formaldehyde or glutaraldehyde (as taught in WO 2017/009786 A1), instead of heavy metals for the regular tanning treatment of Ihide.

This type of tanning is not very diffused and actually, with the advent of chromium tanning it has slowly fallen into disuse for various reasons, including the fact that the hide tanned according to this method, tends to yellow, is “flat” and, therefore, scarcely appreciated for subsequent processing.

Nowadays, the use of aldehydes in tanning methods is thus limited to support tanning treatments employing heavy metals and in particular occurs during hide pre-tanning and post-tanning steps (as taught in WO 2016/170503 A1 and U.S. Pat. No. 5,011,499).

There is, however, the need to provide a hide tanning method, which is alternative to traditional methods, which solves the above mentioned drawbacks.

More particularly, the object of the present invention is to provide a tanning method for hide, which allows producing metal-free tanned hide.

Another object of the present invention is to provide a tanning method for hide, which allows producing less allergenic hide than that produced according to traditional methods.

Still another object of the present invention is to provide a tanning method for hide, which allows producing hide than can be disposed of more easily than traditional methods.

Not the last object of the present invention is to provide a tanning method allowing producing hide suitable for being processed, i.e. able to maintain high standards of softness, fullness to the touch, elasticity, resistance to tearing, etc. at least comparable to those of hide tanned with non-metal-free traditional methods.

Before going into the merit of the present invention it is clarified that in the present description and in the following claims, when the term “about” is used to refer to a particular value or range, the accuracy of this value or range is related to the method used to measure it. Moreover, if specific margins of error are not indicated, each value or range is considered as rounded to that value or range. For example:
the expression “about 200° C.” is interpreted as referring to a value that, rounded, corresponds to 200° C.;
the expression “ . . . comprised between about 1% and 3% by weight . . . ” is interpreted as referring to a range that, when rounded, is “ . . . between 1% and 3% by weight . . . ”.

It is a specific object of the present invention a method for metal-free tanning a quantity of hide having initial weight w, said quantity of hide being contained in a drum, wherein said method 1 comprises at least one tanning treatment B of said hide including at least the following operating steps:
B.1 feeding aliphatic aldehyde into said drum, in a percentage ranging between about 1% and 3% by weight with respect to the initial weight w of said hide, optionally equal to about 2% by weight, and
B.2 moving said drum for a time period of at least about 10 min, optionally approximately 20 min at an operating speed between 1 and 8 revolutions/minute, preferably comprised between 4 and 5 revolutions/minute;
B.3 feeding citric acid into said drum, in a percentage ranging between about 0.1% and 0.3% by weight with respect to the initial weight w of said hide, optionally equal to about 0.2% by weight, and
B.4 moving said drum for a time period of at least about other 10 min, optionally approximately 20 min at said operating speed;
B.5 feeding aliphatic aldehyde into said drum, in a percentage ranging between about 1% and about 3% by weight with respect to the initial weight w of said hide, optionally equal to about 2% by weight, and
B.6 moving said drum for a time period of at least about 150 min, optionally approximately 180 min at said operating speed;
B.7 feeding sodium formate into said drum, in a percentage ranging between about 0.3% and about 0.7% by weight with respect to the initial weight w of said hide, optionally equal to about 0.5% by weight, and
B.8 moving said drum for a time period of at least about 20 min, optionally approximately 30 min at said operating speed;
B.9 feeding magnesium oxide into said drum, in a percentage ranging between about 0.3% and about 0.7% by weight with respect to the initial weight w of said hide, optionally equal to about 0.5% by weight, and
B.10 moving said drum for a time period of at least about 60 min, optionally approximately 90 min at said operating speed;
B.11 feeding water into said drum, at a temperature ranging between about 30° C. and about 60° C., optionally equal to about 50° C., in a percentage ranging between about 30% and 50% by weight with respect to the initial weight w of said hide, optionally equal to about 40% by weight, and
B.12 moving said drum for a time period of at least about 100 min, optionally approximately 120 min at said operating speed;
B.13 feeding aliphatic aldehyde into said drum, in a percentage ranging between about 1% and 5% by weight with respect to the initial weight w of said hide, optionally equal to about 3% by weight, and
B.14 moving said drum for a time period of at least about 100 min, optionally approximately 120 min at said operating speed; and then
B.15 moving said drum for a maintaining period comprised between about 10 and about 16 hours, optionally approximately 14 hours, at a first maintaining speed ranging between about 1 and 5 revolutions/hour, optionally comprised between 2 and 4 revolutions/hour, even more optionally equal to about 3 revolutions/hour.

According to another aspect of the invention, after said step B.15 said method can comprise at least one step B.16 to remove metal residues, comprising:
B.161 feeding water into said drum, at a temperature ranging between about 10° C. and about 30° C., optionally equal to about 20° C., in a percentage ranging between about 180% and 250% by weight with respect to the initial weight w of said hide, optionally equal to about 200% by weight,
B.162 feeding a chelating substance into said drum, in a percentage ranging between about 0.1% and 0.3% by weight with respect to the initial weight w of said hide, optionally equal to about 0.2% by weight; and
B.163 moving said drum for a time period of at least about 10 min, optionally approximately 15 min at said operating speed.

According to a further aspect of the invention, at the end of said step B.15 and at the end of said step B.16, if performed, said method can comprise at least one draining and flushing step B.17 of said hide thereby treated, including:
B.171 draining, at stationary drum, the liquid contained into said drum;
B.172 feeding water into said drum, at a temperature ranging between about 10° C. and about 30° C., optionally equal to about 20° C., in a percentage ranging between about 180% and 220% by weight with respect to the initial weight w of said hide, optionally equal to about 200% by weight;
B.0173 moving said drum for a time period of at least about 5 min, optionally approximately 10 min at said operating speed; and
B.174 draining again the liquid contained in said drum.

According to an additional aspect of the invention, before said tanning treatment B said method can comprise at least one pre-tanning treatment A of said hide contained into said drum, including at least one step A.1 of de-calcination and degreasing of said hide to be treated, comprising:
A.111 feeding water into said drum, at a temperature ranging between about 25° C. and about 30° C., optionally equal to about 27° C., in a percentage ranging between about 100% and 150% by weight with respect to the initial weight w of said hide, optionally equal to about 120% by weight;
A.112 feeding Marseilles soap into said drum, in a percentage ranging between about 0.1% and 0.3% by weight with respect to the initial weight w of said hide, optionally equal to about 0.2% by weight;
A.113 feeding ammonium sulphate into said drum, in a percentage ranging between about 0.20% and 0.30% by weight with respect to the initial weight w of said hide, optionally equal to about 0.25% by weight;
A.114 moving said drum for a time period of at least about 20 min, optionally approximately 30 min at said operating speed; and
A.115 draining at stationary drum the liquid contained into said drum.

According to another aspect of the invention, said step A.1 of de-calcination and degreasing of said hide to be treated, can comprise, subsequently:
A.116 feeding water into said drum, at a temperature ranging between about 25° C. and about 35° C., optionally equal to about 30° C., in a percentage ranging between about 30% and 70% by weight with respect to the initial weight w of said hide, optionally equal to about 50% by weight;
A.117 feeding Marseilles soap into said drum, in a percentage ranging between about 0.05% and 0.15% by weight with respect to the initial weight w of said hide, optionally equal to about 0.1% by weight;
A.118 feeding ammonium hydroxide into said drum, in a percentage ranging between about 0.3% and 0.7% by weight with respect to the initial weight w of said hide, optionally equal to about 0.5% by weight;
A.119 feeding acetic acid into said drum, in a percentage ranging between about 0.3% and 0.7% by weight with respect to the initial weight w of said hide, optionally equal to about 0.5% by weight;
A.120 moving said drum for a time period of at least about 20 min, optionally approximately 30 min at said operating speed;
A.121 feeding again acetic acid into said drum, in a percentage ranging between about 0.3% and 0.7% by weight with respect to the initial weight w of said hide, optionally equal to about 0.5% by weight;
A.122 feeding ammonium acetate into said drum, in a percentage ranging between about 0.5% and 1.5% by weight with respect to the initial weight w of said hide, optionally equal to about 1% by weight;
A.123 moving said drum for a time period of at least about 150 min, optionally approximately 180 min at said operating speed; and
A.124 draining at stationary drum the liquid contained into said drum.

According to a further aspect of the invention, between said step A.115 and said step A.116 at least one bleaching step of said skin can be included, comprising:
A.125 feeding water into said drum, at a temperature ranging between about 25° C. and about 35° C., optionally equal to about 30° C., in a percentage ranging between about 100% and 150% by weight with respect to the initial weight w of said hide, optionally equal to about 120% by weight;
A.126 feeding hydrogen peroxide into said drum, in a percentage ranging between about 0.3% and 0.7% by weight with respect to the initial weight w of said hide, optionally equal to about 0.5% by weight;
A.127 moving said drum for a time period of at least about 10 min, optionally approximately 20 min at said operating speed; and
A.128 draining at stationary drum the liquid contained into said drum.

According to a further aspect of the present invention, before said tanning treatment B and after said step A.1 of de-calcination and degreasing of said hide to be treated, said method can comprise at least one maceration treatment A.2 of said hide contained into said drum, including:
A.211 feeding water into said drum, at a temperature ranging between about 30° C. and about 40° C., optionally equal to about 35° C., in a percentage ranging between about 80% and 120% by weight with respect to the initial weight w of said hide, optionally equal to about 100% by weight;
A.212 feeding Marseilles soap into said drum, in a percentage ranging between about 0.05% and 0.15% by weight with respect to the initial weight w of said hide, optionally equal to about 0.1% by weight;
A.213 feeding sheep serum into said drum, in a percentage ranging between about 0.2% and 0.6% by weight with respect to the initial weight w of said hide, optionally equal to about 0.4% by weight;
A.214 moving said drum for a time period of at least about 20 min, optionally approximately 30 min at said operating speed; and then
A.215 draining at stationary drum the liquid contained into said drum, feeding water into said drum at a temperature ranging between about 15° C. and about 25° C., optionally equal to about 20° C., in a percentage ranging between approximately 80% and 120% by weight with respect to the initial weight w of the hide, optionally equal to about 100% by weight, and moving the drum for a time period of at least about 5 min, optionally equal to about 10 min at said operating speed and draining again the liquid contained into the drum.

According to another aspect of the invention, before said tanning treatment B and after said step A.2 of de-calcination and degreasing of said hide to be treated, said method can comprise at least one pickling treatment A.3 of said hide contained into said drum, including:
A.311 feeding water into said drum, at a temperature ranging between about 10° C. and about 30° C., optionally equal to about 20° C., in a percentage ranging between about 10% and 30% by weight with respect to the initial weight w of said hide, optionally equal to about 20% by weight;
A.312 feeding industrial salt into said drum, in a percentage ranging between about 4% and 8% by weight with respect to the initial weight w of said hide, optionally equal to about 6% by weight;
A.313 feeding sodium formate into said drum, in a percentage ranging between about 0.3% and 0.7% by weight with respect to the initial weight w of said hide, optionally equal to about 0.5% by weight;
A.314 feeding extra-virgin olive oil into said drum, in a percentage ranging between about 0.5% and 1.5% by weight with respect to the initial weight w of said hide, optionally equal to about 1% by weight, and
A.315 moving said drum for a time period of at least about 10 min, optionally approximately 15 min at said operating speed;
A.316 feeding formic acid into said drum, in a percentage ranging between about 0.6% and 1% by weight with respect to the initial weight w of said hide, optionally equal to about 0.8% by weight, and
A.317 moving said drum for a time period of at least about 20 min, optionally approximately 30 min at said operating speed;
A.318 feeding sulphuric acid into said drum, at a concentration ranging between 40% and 60%, optionally equal to about 50%, in a percentage ranging between about 1% and 1.2% by weight with respect to the initial weight w of said hide, optionally equal to about 1% by weight, and
A.319 moving said drum for a time period of at least about 150 min, optionally approximately 180 min at said operating speed; and
A.320 moving said drum for a maintaining period comprised between about 10 and about 14 hours, optionally approximately 12 hours, at said first maintaining speed.

According to a further aspect of the invention, said method can further comprise at least one step A.321 of actuating said drum for a time period of at least about 5 min, optionally approximately 10 min, before said tanning treatment B.

According to an additional aspect of the invention, after said tanning treatment B at least one post-tanning treatment C of said hide contained in a drum and having initial weight w1, wherein w1<w, can be comprised, said post-tanning treatment including at least one first re-tanning, dyeing and fattening treatment C.2, comprising:
C.211 feeding water into said drum, at a temperature ranging between about 20° C. and about 40° C., optionally equal to about 30° C., in a percentage ranging between about 120% and 180% by weight with respect to the initial weight w1 of said hide, optionally equal to about 150% by weight; C.212 feeding sodium bicarbonate into said drum, in a percentage ranging between about 0.3% and 0.7% by weight with respect to the initial weight w1 of said hide, optionally equal to about 0.5% by weight;
C.213 feeding sulphonic acid into said drum, in a percentage ranging between about 1% and 3% by weight with respect to the initial weight w1 of said hide, optionally equal to about 2% by weight; and
C.214 moving said drum for a time period of at least about 30 min, optionally approximately 40 min at said operating speed; then
C.215 feeding sulphonic acid into said drum, in a percentage ranging between about 3% and 5% by weight with respect to the initial weight w1 of said hide, optionally equal to about 4% by weight;
C.216 feeding acetic acid into said drum, in a percentage ranging between about 3% and 5% by weight with respect to the initial weight w1 of said hide, optionally equal to about 4% by weight;
C.217 feeding formic acid into said drum, in a percentage ranging between about 3% and 5% by weight with respect to the initial weight w1 of said hide, optionally equal to about 4% by weight;
C.218 feeding a filler into said drum, optionally flour, in a percentage ranging between about 3% and 5% by weight with respect to the initial weight w1 of said hide, optionally equal to about 4% by weight;
C.219 feeding Tara extract into said drum, in a percentage ranging between about 3% and 5% by weight with respect to the initial weight w1 of said hide, optionally equal to about 4% by weight;
C.220 feeding cationic surfactants into said drum, in a percentage ranging between about 1% and 5% by weight with respect to the initial weight w1 of said hide, optionally equal to about 3% by weight;
C.221 feeding a dye into said drum, optionally a coloured pigment, optionally white, in a percentage ranging between about 1% and 2% by weight with respect to the initial weight w1 of said hide, optionally equal to about 1.5% by weight, or a metal free aniline, in a percentage that is a function of the initial weight w1 of said hide and the intensity of the colour of said hide which is to be obtained;
C.222 feeding lecithin into said drum, in a percentage ranging between about 1% and 3% by weight, with respect to the initial weight w1 of said hide, optionally equal to about 2% by weight; and
C.223 moving said drum for a time period of at least about 40 min, optionally approximately 60 min at said operating speed; then
C.224 feeding sulphonic acid into said drum, in a percentage ranging between about 3% and 5% by weight with respect to the initial weight w1 of said hide, optionally equal to about 4% by weight;
C.225 feeding acetic acid into said drum, in a percentage ranging between about 3% and 5% by weight with respect to the initial weight w1 of said hide, optionally equal to about 4% by weight;
C.226 feeding formic acid into said drum, in a percentage ranging between about 3% and 5% by weight with respect to the initial weight w1 of said hide, optionally equal to about 4% by weight;
C.227 feeding a filler into said drum, optionally flour, in a percentage ranging between about 3% and 5% by weight with respect to the initial weight w1 of said hide, optionally equal to about 4% by weight;
C.228 feeding Tara extract into said drum, in a percentage ranging between about 3% and 5% by weight with respect to the initial weight w1 of said hide, optionally equal to about 4% by weight;
C.229 moving said drum for a time period of at least about 40 min, optionally approximately 60 min at said operating speed; and
C.230 moving said drum for a maintaining period comprised between about 10 and about 16 hours, optionally approximately 14 hours at a second maintaining speed, which optionally comprises moving said drum for 5 minutes at a speed of about 1 revolution per min and stopping said drum for the next 25 minutes.

According to another aspect of the invention, after said first treatment C.2 at least another post-tanning treatment C of said hide contained in said drum can be comprised, including at least one second dyeing and fattening treatment C.4, comprising:
C.411 feeding water into said drum, at a temperature ranging between about 40° C. and 60° C., optionally equal to about 50° C., in a percentage ranging between about 120% and 180% by weight with respect to the initial weight w1 of said hide, optionally equal to about 150% by weight;
C.412 feeding a dye into said drum, optionally a coloured pigment, optionally white, in a percentage ranging between about 1% and 2% by weight with respect to the initial weight w1 of said hide, optionally equal to about 1.5% by weight, or a metal free aniline, in a percentage that is a function of the initial weight w1 of said hide and the intensity of the colour of said hide which is to be obtained;

C.413 feeding cationic surfactants into said drum, in a percentage ranging between about 4% and 8% by weight with respect to the initial weight w1 of said hide, optionally equal to about 6% by weight;
C.414 feeding lecithin into said drum, in a percentage ranging between about 4% and 8% by weight, with respect to the initial weight w1 of said hide, optionally equal to about 6% by weight;
C.415 feeding sodium glutamate into said drum, in a percentage ranging between about 4% and 6% by weight with respect to the initial weight w1 of said hide, optionally equal to about 5% by weight;
C.416 feeding Marseilles soap into said drum, in a percentage ranging between about 0.3% and 0.7% by weight with respect to the initial weight w1 of said hide, optionally equal to about 0.5% by weight;
C.417 moving said drum for a time period of at least about 40 min, optionally approximately 60 min at said operating speed; then
C.418 feeding formic acid into said drum, in a percentage ranging between about 1% and 3% by weight with respect to the initial weight w1 of said hide, optionally equal to about 2% by weight; and
C.419 moving said drum for a time period of at least about 70 min, optionally approximately 90 min at said operating speed.

According to a further aspect of the invention, between said first treatment C.2 and said second treatment C.4 at least one fixing treatment C.3 can be comprised, including:
C.311 feeding water into said drum, at a temperature ranging between about 40° C. and 60° C., optionally equal to about 50° C., in a percentage ranging between about 180% and 220% by weight with respect to the initial weight w1 of said hide, optionally equal to about 200% by weight;
C.312 feeding formic acid into said drum, in a percentage ranging between about 0.5% and 1.5% by weight with respect to the initial weight w1 of said hide, optionally equal to about 1% by weight; and
C.313 moving said drum for a time period of at least about 20 min, optionally approximately 30 min at said operating speed; then
C.314 feeding formic acid into said drum, in a percentage ranging between about 0.5% and 1.5% by weight with respect to the initial weight w1 of said hide, optionally equal to about 1% by weight; and
C.315 moving said drum for a time period of at least about 40 min, optionally approximately 60 min at said operating speed.

According to an additional aspect of the invention, right after said second treatment C.4 at least one more fixing treatment C.5 can be comprised, including:
C.511 feeding water into said drum, at a temperature ranging between about 10° C. and 30° C., optionally equal to about 20° C., in a percentage ranging between about 180% and 220% by weight with respect to the initial weight w1 of said hide, optionally equal to about 200% by weight;
C.512 feeding citric acid into said drum, in a percentage ranging between about 0.5% and 1.5% by weight with respect to the initial weight w1 of said hide, optionally equal to about 1% by weight; and
C.513 moving said drum for a time period of at least about 10 min, optionally approximately 20 min at said operating speed.

According to another aspect of the invention, right before the execution of said first treatment C.2 said post-tanning treatment can comprise at least one washing treatment C.1, including:
C.111 feeding water into said drum, at a temperature ranging between about 10° C. and 30° C., optionally equal to about 20° C., in a percentage ranging between about 180% and 220% by weight with respect to the initial weight w1 of said hide, optionally equal to about 200% by weight;
C.112 feeding a chelating substance into said drum, in a percentage ranging between about 0.3% and 0.7% by weight with respect to the initial weight w1 of said hide, optionally equal to about 0.5% by weight;
C.113 feeding oxalic acid into said drum, in a percentage ranging between about 0.1% and 0.5% by weight with respect to the initial weight w1 of said hide, optionally equal to about 0.3% by weight; and
C.114 moving said drum for a time period of at least about 30 min, optionally approximately 40 min at said operating speed.

According to a further aspect of the invention, after the execution of said second treatment C.4, optionally after said further fixing treatment C.5, said post-tanning treatment C can comprise at least one further washing treatment C.6, including:
C.611 feeding water into said drum, at a temperature ranging between about 10° C. and 30° C., optionally equal to about 20° C., in a percentage ranging between about 180% and 220% by weight with respect to the initial weight w1 of said hide, optionally equal to about 200% by weight;
C.612 feeding a chelating substance into said drum, in a percentage ranging between about 0.5% and 1.5% by weight with respect to the initial weight w1 of said hide, optionally equal to about 1% by weight; and
C.613 moving said drum for a time period of at least about 5 min, optionally approximately 10 min at said operating speed.

According to an additional aspect of the invention, at the end of said steps C.1, C.3, C.4, C.5 and C.6, when performed, said method can comprise at least one step C.00 including:
draining, at stationary drum, the liquid contained into said drum;
feeding water into said drum, at a temperature ranging between about 10° C. and 30° C., optionally equal to about 20° C., in a percentage ranging between about 180% and 220% by weight with respect to the initial weight w1 of said hide, optionally equal to about 200% by weight;
moving said drum for a time period of at least about 5 min, optionally approximately 10 min at said operating speed; and
draining again the liquid contained in said drum.

The present invention will be now described, for illustrative but not limiting purposes, according to its preferred embodiments, with particular reference to the Figures of the accompanying drawings, wherein:

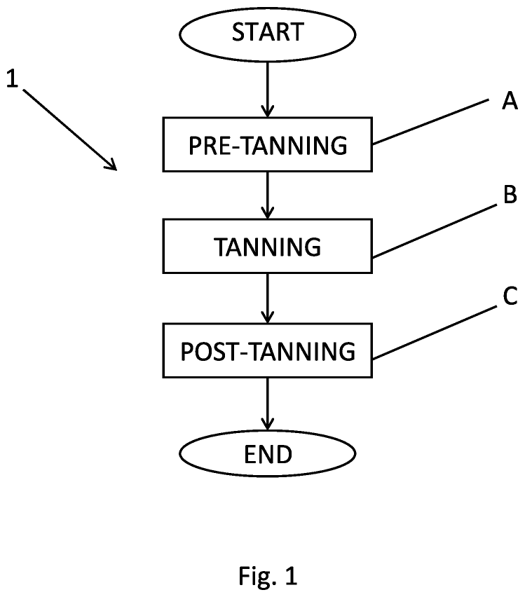

FIG. 1 shows a flow diagram of the main steps undergone by the hide during the tanning method according to the present invention;

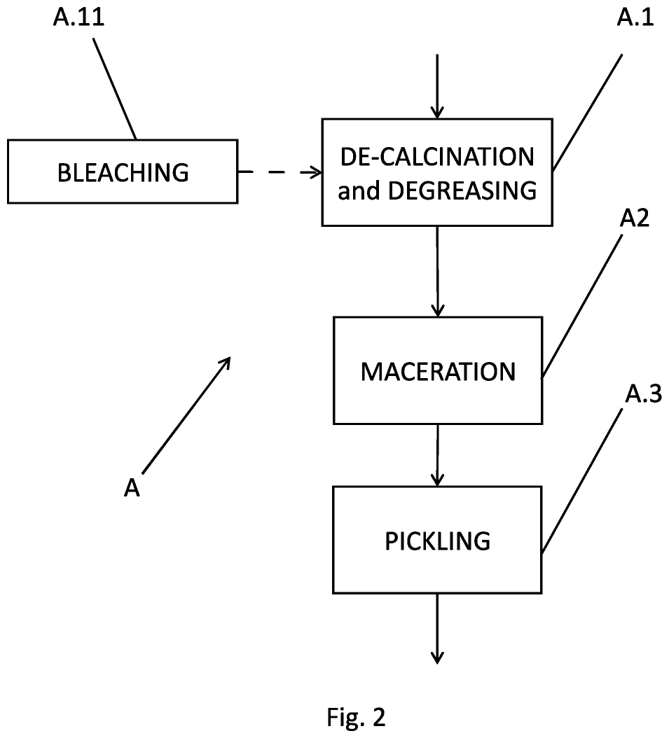

FIG. 2 is a flow diagram illustrating in detail the treatments undergone by the hide, during the pre-tanning treatment of the method according to the present invention;

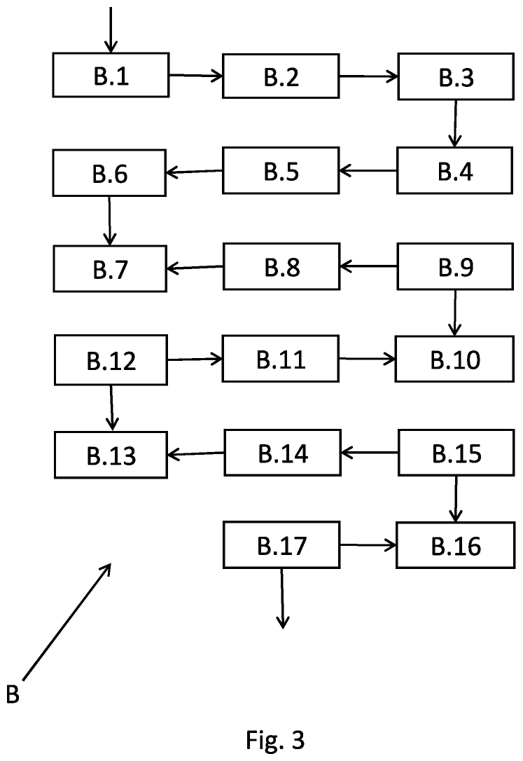

FIG. 3 shows a flow chart of the steps of the of real hide tanning treatment, according to the method of the present invention;

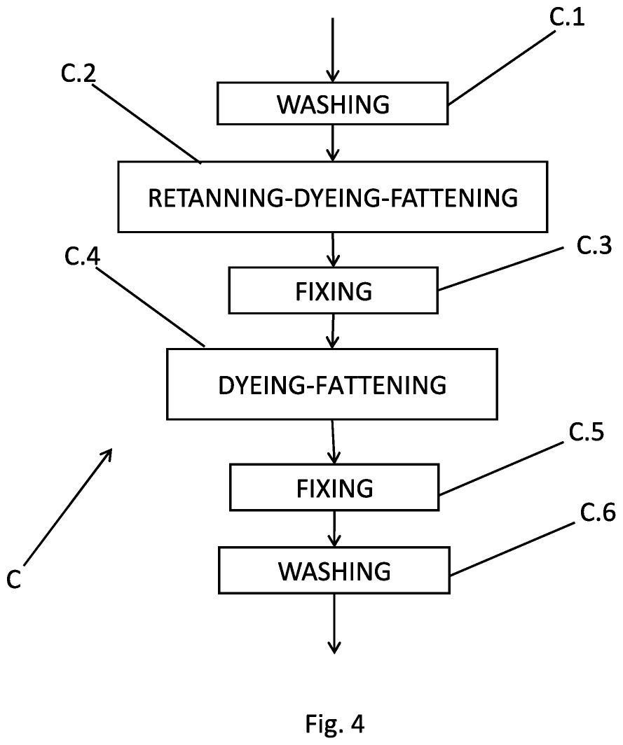

FIG. 4 is a flow diagram illustrating in detail the treatments undergone by the hide, during the post-tanning treatment of the method according to the present invention;

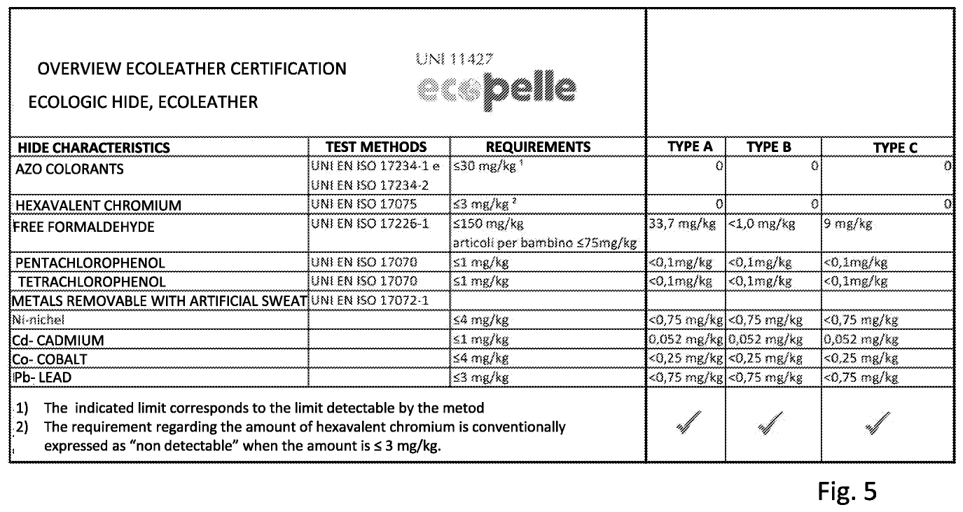

FIG. 5 is a table summarizing reference concentrations of some substances relevant for the determination of one “eco-leather” and the measured concentrations in tanned hide according to the method of the present invention; and

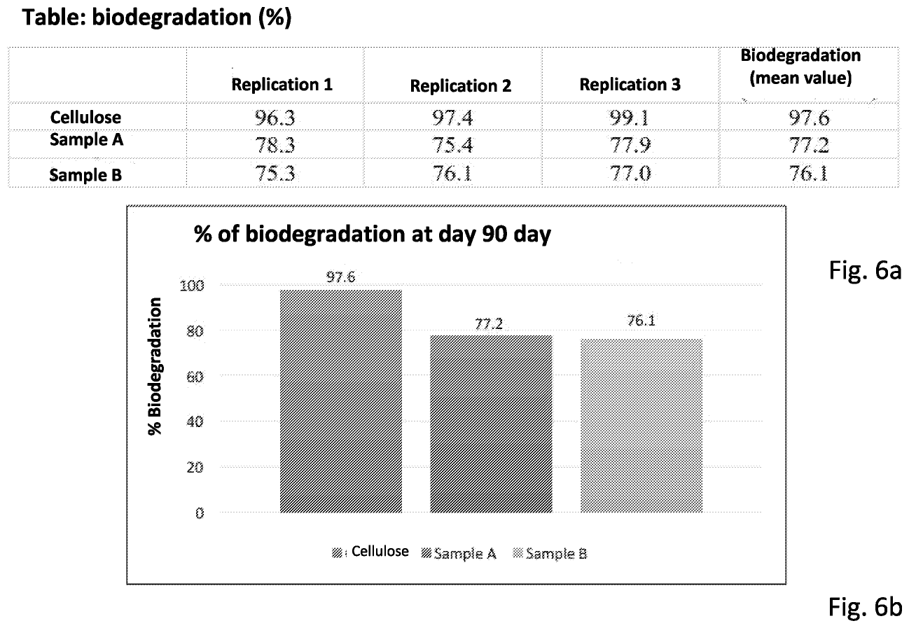

FIGS. 6a and 6b show in a table and in a histogram, respectively, biodegradability levels measured in a sample of tanned hide according to the method of the present invention.

Before going into the merits of the method according to the present invention it is recalled that, in general, a method of tanning hides comprises the use of a “drum”, i.e. a hollow cylindrical body, for example made of wood or metal, disposed with its longitudinal axis substantially horizontal and supported, at said axis by means of a hollow shaft extending longitudinally therethrough. This hollow shaft, through suitable apertures provided for the purpose, allows feeding water and other liquid chemical compounds in the cylinder, required for the execution of the tanning method and allows the exit of gases which are formed during the method.

The hollow shaft is integral with the cylindrical body of the drum and is operable by a suitable motor group, whereby the hollow cylindrical body can rotate around its longitudinal axis and move the hide to be treated, the water and the chemical compounds contained therein, in order to facilitate the absorption of those chemical compounds by the hide.

The cylindrical body is accessible from the outside by means of an opening formed therein (fluid tightly closable by means of a suitable door), useful for the introduction into the cylindrical body of the hide to be treated and of possible powder compounds which, according to the tanning method, must be inserted directly into the cylindrical body. The door is also useful for unloading the hide and/or the treatment liquid (water+chemical compounds) contained in the cylindrical body, during the steps normally provided for the washing and draining of the drum and/or hide contained therein. The feeding of water and of one or more liquid chemical compounds inside the drum always occurs while the drum rotates about its longitudinal axis. The feeding of one or more powder chemical compounds inside the drum takes place with the drum stationary.

With reference to FIGS. 1 to 4, it will be noted that a metal-free tanning method according to the present invention, is indicated with the reference numeral 1 and comprises, in the regular tanning treatment B of a quantity of hide having initial weight w (where w indicates the weight of the hide before undergoing any treatment of pre-tanning, tanning and post-tanning) and housed inside a suitable drum (see in particular FIG. 3), at least the following operating steps:
B.1 feeding aliphatic aldehyde into the drum, in a percentage ranging between about 1% and 3% by weight with respect to the initial weight (w) of the hide, optionally equal to about 2% by weight, and
B.2 moving the drum for a time period of at least about 10 min, optionally approximately 20 min at an operating speed between 1 and 8 revolutions/minute, preferably comprised between 4 and 5 revolutions/minute;
B.3 feeding citric acid into the drum, in a percentage ranging between about 0.1% and 0.3% by weight with respect to the initial weight (w) of the hide, optionally equal to about 0.2% by weight, and
B.4 moving the drum for a time period of at least about other 10 min, optionally approximately 20 min at the above mentioned operating speed;
B.5 feeding aliphatic aldehyde into the drum, in a percentage ranging between about 1% and about 3% by weight with respect to the initial weight (w) of the hide, optionally equal to about 2% by weight, and
B.6 moving the drum for a time period of at least about 150 min, optionally approximately 180 min at the above mentioned operating speed;
B.7 feeding sodium formate into the drum, in a percentage ranging between about 0.3% and about 0.7% by weight with respect to the initial weight (w) of the hide, optionally equal to about 0.5% by weight, and
B.8 moving the drum for a time period of at least about 20 min, optionally approximately 30 min at the above mentioned operating speed;
B.9 feeding magnesium oxide into the drum, in a percentage ranging between about 0.3% and about 0.7% by weight with respect to the initial weight (w) of the hide, optionally equal to about 0.5% by weight, and
B.10 moving the drum for a time period of at least about 60 min, optionally approximately 90 min at the above mentioned operating speed;
B.11 feeding water into the drum, at a temperature ranging between about 30° C. and about 60° C., optionally equal to about 50° C., in a percentage ranging between about 30% and 50% by weight with respect to the initial weight (w) of the hide, optionally equal to about 40% by weight, and
B.12 moving the drum for a time period of at least about 100 min, optionally approximately 120 min at the above mentioned operating speed;
B.13 feeding aliphatic aldehyde into the drum, in a percentage ranging between about 1% and 5% by weight with respect to the initial weight (w) of the hide, optionally equal to about 3% by weight, and
B.14 moving the drum for a time period of at least about 100 min, optionally approximately 120 min at the above mentioned operating speed; and then
B.15 moving the drum for a maintaining period comprised between about 10 and about 16 hours, optionally approximately 14 hours, at a first maintaining speed ranging between about 1 and 5 revolutions/hour, optionally comprised between 2 and 4 revolutions/hour, even more optionally equal to about 3 revolutions/hour.

At the end of step B.15, the hide is expected to have a sectional pH comprised between about 3.7 and about 4.3, optionally equal to 4.1.

As can be seen, the regular tanning treatment B described above does not make use of heavy metals.

Step B.15 is a step in the tanning method 1 according to the present invention that is usually carried out at night, during which the hide is mixed with the treatment liquid (water+components added time by time as described above) at a much lower speed than the operating speed and so it has enough time to absorb the chemical compounds contained in the treatment liquid.

At the end of said step B.15, the tanning method 1 according to the present invention advantageously comprises one step B.16 of removing any metal residues, which may have been released into the drum, during the movement of the same (for example, if the drum is made with metal elements that can come into contact with the hide and/or the treatment liquid), due to the movement of the hide immersed into/soaked with treatment liquid, against its internal walls.

Step B.16, comprises, for this purpose:
B.161 feeding water into the drum, at a temperature ranging between about 10° C. and about 30° C., optionally equal to about 20° C., in a percentage ranging between about 180% and 250% by weight with respect to the initial weight (w) of the hide, optionally equal to about 200% by weight;
B.162 feeding a chelating substance into the drum, in a percentage ranging between about 0.1% and 0.3% by weight with respect to the initial weight w of the hide, optionally equal to about 0.2% by weight; and
B.163 moving the drum for a time period of at least about 10 min, optionally approximately 15 min at the above mentioned operating speed.

The method 1 according to the present invention, at the end of step B.15 and, if provided, at the end of step B.16, comprises at least one step B.17 of draining and flushing the hide contained in the drum, including:
B.171 draining the liquid contained into the drum (opening, for example, the fluid tight door formed into the cylindrical body of the drum);
B.172 feeding water into the drum, at a temperature ranging between about 10° C. and about 30° C., optionally equal to about 20° C., in a percentage ranging between about 180% and 220% by weight with respect to the initial weight (w) of the hide, optionally equal to about 200% by weight;
B.173 moving the drum for a time period of at least about 5 min, optionally approximately 10 min at the above mentioned operating speed; and
B.174 draining again the liquid contained into said drum as above.

It should be noted that the draining operations for the treatment liquid contained into the drum comprise the stop of the movement of the drum for the minimum time required to drain the treatment liquid contained therein.

The hide to be treated, as anticipated in the introduction, is pre-treated before undergoing the regular tanning treatment B, in order to lower its pH to a value typically comprised between 3 and 4.

The pre-tanning A of the method 1 according to the present invention (see FIG. 2) includes at least one treatment A.1 of de-calcination and degreasing of the hide to be treated, which usually comes swollen, turgescent and strongly alkaline from the previous processing steps, being therefore not suitable to be subjected to the tanning treatment. The de-calcination, besides lowering the alkaline pH of the hide to values between about 7 and 9, removes the swelling and the turgidity of the hide, eliminating the lime and the sulfide contained therein. The degreasing, moreover, eliminates or reduces the natural fat in excess into the hide to be treated, which could cause difficulties in the absorption and fixation of chemical products during the regular tanning treatment.

Such treatment A.1 of de-calcination and degreasing comprises: A.111 feeding water into the drum, at a temperature ranging between about 25° C. and about 30° C., optionally equal to about 27° C., in a percentage ranging between about 100% and 150% by weight with respect to the initial weight (w) of the hide, optionally equal to about 120% by weight;
A.112 feeding Marseilles soap into the drum, in a percentage ranging between about 0.1% and 0.3% by weight with respect to the initial weight w of the hide, optionally equal to about 0.2% by weight;
A.113 feeding ammonium sulphate into the drum, in a percentage ranging between about 0.20% and 0.30% by weight with respect to the initial weight w of the hide, optionally equal to about 0.25% by weight; and
A.114 moving the drum for a time period of at least about 20 min, optionally approximately 30 min at the above mentioned operating speed.

At the end of the movement of the drum (A.114), the method 1 according to the present invention comprises a step A.115 of drainage, at stationary drum as indicated above, of the liquid therein contained. At the end of step A.114 the hide is expected to have a pH, measured in cross section (i.e. within the skin and not into the treatment liquid) roughly comprised between 10 and 11, optionally a little more than 10, for example equal to 10.16.

Of course, the above described steps (for example from A.111 to A.113) that comprise the feeding into the drum of water and one or more components before moving the same drum, can be carried out in sequence, in a different order from that indicated above, or they can be performed simultaneously, for example in the case wherein all the components to be fed into the drum (in addition to water) are liquid.

Generally, in fact, in the case wherein one or more liquid components and one or more powder components needs to be fed into the drum, before its movement, the method 1 of the present invention comprises first feeding into the drum all the liquid components (water included) simultaneously, and then all the powder components simultaneously or vice versa, provided that when the drum is moved, all required components are present therein.

Returning to the method 1 of the present invention, the step of de-calcination and degreasing of the hide, subsequently comprises:
A.116 feeding water into the drum, at a temperature ranging between about 25° C. and about 35° C., optionally equal to about 30° C., in a percentage ranging between about 30% and 70% by weight with respect to the initial weight (w) of the hide, optionally equal to about 50% by weight;
A.117 feeding Marseilles soap into the drum, in a percentage ranging between about 0.05% and 0.15% by weight with respect to the initial weight w of the hide, optionally equal to about 0.1% by weight;
A.118 feeding ammonium hydroxide into the drum, in a percentage ranging between about 0.3% and 0.7% by weight with respect to the initial weight w of the hide, optionally equal to about 0.5% by weight;
A.119 feeding acetic acid into the drum, in a percentage ranging between about 0.3% and 0.7% by weight with respect to the initial weight (w) of the hide, optionally equal to about 0.5% by weight; and
A.120 moving the drum for a time period of at least about 20 min, optionally approximately 30 min at the above mentioned operating speed.

Then, the treatment A.1 of de-calcination and degreasing of the hides proceeds according to the following steps:
A.121 feeding again acetic acid into the drum, in a percentage ranging between about 0.3% and 0.7% by weight with respect to the initial weight (w) of the hide, optionally equal to about 0.5% by weight;
A.122 feeding ammonium hydroxide into the drum, in a percentage ranging between about 0.5% and 1.5% by weight with respect to the initial weight w of the hide, optionally equal to about 1% by weight;
A.123 moving the drum for a time period of at least about 150 min, optionally approximately 180 min at the above mentioned operating speed.

At the end of the movement of the drum (A.123), the method 1 according to the present invention comprises a step A.124 of drainage, thereby at stationary drum, of the liquid therein contained. At the end of step A.123, the hide is expected to have a (sectional) pH roughly comprised between about 7.5 and about 7.7, optionally equal to 7.6.

According to a variation of the method 1 of the present invention, between step A.115 and step A.116 a bleaching treatment of the hide is optionally comprised, aimed at providing the hide a clear colouring. Such bleaching treatment, comprises:
A.125 feeding water into the drum, at a temperature ranging between about 25° C. and about 35° C., optionally equal to about 30° C., in a percentage ranging between about 100% and 150% by weight with respect to the initial weight (w) of the hide, optionally equal to about 120% by weight;
A.126 feeding hydrogen peroxide into the drum, in a percentage ranging between about 0.3% and 0.7% by weight with respect to the initial weight (w) of the hide, optionally equal to about 0.5% by weight; and
A.127 moving the drum for a time period of at least about 10 min, optionally approximately 20 min at the above mentioned operating speed.

As expected at the end of step A.114 and A.123, even at the end of step A.127, if the bleaching of the hide is carried out, the method 1 of the present invention comprises at least one step A.128 of draining the liquid contained into the drum. At the end of step A.127, the hide is expected to have a sectional pH roughly equal to about 10, optionally a little lower than 10, for example equal to 9.95.

After the treatment of de-calcination and degreasing A.1, and before the tanning treatment B, the method 1 according to the present invention comprises one maceration treatment A.2 of the hide contained into the drum, aiming at completing the de-calcination of the hide, eliminating residues of any inter-fibrillar and not useful substances, loosen the fibrous structure of the hide so as to encourage the expulsion of the skin pigments (melanins) and the hair roots still remained englobed and producing a soft and yielding hide.

The maceration treatment A.2 of the method 1 according to the present invention comprises:
A.211 feeding water into the drum, at a temperature ranging between about 30° C. and about 40° C., optionally equal to about 35° C., in a percentage ranging between about 80% and 120% by weight with respect to the initial weight (w) of the hide, optionally equal to about 100% by weight;
A.212 feeding Marseilles soap into the drum, in a percentage ranging between about 0.05% and 0.15% by weight with respect to the initial weight w of the hide, optionally equal to about 0.1% by weight;
A.213 feeding sheep serum into the drum, in a percentage ranging between about 0.2% and 0.6% by weight with respect to the initial weight w of the hide, optionally equal to about 0.4% by weight; and
A.214 moving the drum for a time period of at least about 20 min, optionally approximately 30 min at said operating speed.

Then, the tanning method according to the present invention comprises one step (A.215) of draining the treatment liquid, at stationary drum, and cooling the hide that, due to the effect of the chemical reactions occurring during the maceration was immersed in/soaked in the treatment liquid at a temperature of about 30-35° C. This step A.215 specifically includes draining the liquid contained into the stationary drum, feeding into the drum water at a temperature ranging between about 15° C. and about 25° C., optionally equal to about 20° C., in a percentage ranging between about 80% and 120% by weight with respect to the initial weight (w) of the hide and optionally equal to about 100% by weight, moving the drum for a time period of at least about 5 min, optionally approximately 10 min at said operating speed and draining again the liquid contained into the drum.

At the end of the maceration step, the hide is expected to have a sectional pH roughly comprised between 7.8 and about 8, optionally equal to 7.9.

Right after the maceration, the method 1 according to the present invention comprises among the pre-tanning treatments, also one pickling treatment (A.3) of the hide contained into the drum, which has the purpose of processing it in order to facilitate the penetration of the tanning agent in the subsequent tanning treatment.

The pickling treatment A.2 of the method 1 according to the present invention comprises:
A.311 feeding water into the drum, at a temperature ranging between about 10° C. and about 30° C., optionally equal to about 20° C., in a percentage ranging between about 10% and 30% by weight with respect to the initial weight (w) of the hide, optionally equal to about 20% by weight;
A.312 feeding industrial salt into the drum, in a percentage ranging between about 4% and 8% by weight with respect to the initial weight (w) of the hide, optionally equal to about 6% by weight;
A.313 feeding sodium formate into the drum, in a percentage ranging between about 0.3% and about 0.7% by weight with respect to the initial weight (w) of the hide, optionally equal to about 0.5% by weight;
A.314 feeding extra-virgin olive oil into said drum, in a percentage ranging between about 0.5% and 1.5% by weight with respect to the initial weight (w) of the hide, optionally equal to about 1% by weight, and
A.315 moving the drum for a time period of at least about 10 min, optionally approximately 15 min at the above mentioned operating speed; then
A.316 feeding formic acid into the drum, in a percentage ranging between about 0.6% and 1% by weight with respect to the initial weight (w) of the hide, optionally equal to about 0.8% by weight, and
A.317 moving the drum for a time period of at least about 20 min, optionally approximately 30 min at the above mentioned operating speed; then
A.318 feeding sulphuric acid into said drum, at a concentration ranging between 40% and 60%, optionally equal to about 50%, in a percentage ranging between about 1% and 1.2% by weight with respect to the initial weight (w) of the hide, optionally equal to about 1% by weight;
A.319 moving the drum for a time period of at least about 150 min, optionally approximately 180 min at the above mentioned operating speed; and then
A.320 moving the drum for a maintaining period comprised between about 10 and about 14 hours, optionally approximately 12 hours, at the first maintaining speed described above.

At the end of step A.319, the hide is expected to have a sectional pH roughly comprised between about 2.8 and about 3.2, optionally approximately equal to 3. Step A.320 is a step of the method which is usually carried out at night, during which the hide has time to absorb the components mixed with the water contained into the drum, whereby, at the end of step A.320, the sectional pH of the hide is expected to be changed, and to be substantially comprised between 3.5 and 3.6, optionally equal to 3.4.

At the end of that step A.320, the tanning method according to the present invention comprises one step of driving the drum (A.321), in order to move the hide and the liquid contained into the drum, before the regular tanning treatment (B). In this step, the drum is moved for a time period of at least about 5 min, optionally approximately 10 min.

Subsequently to the actual tanning treatment B undergone by the hide, as it is known in the field, one pressing step of the hide thereby tanned, one splitting step and one trimming step are performed. These steps have the purpose of eliminating from the tanned hide, which is soaked into the treatment liquid, a large part of the treatment liquid, equalizing the thickness thereof and separating the grain from the flesh split, respectively, for subsequent processing operations.

Then, the hide is further treated to make it assume the characteristics of thickness and softness and colour necessary for final processing.

It should be noted that drums of smaller dimensions than those used for pre-tanning and tanning treatments are used for the post-tanning treatment, because the initial weight (w1) of the hide, at the end of the trimming step, i.e. the weight of the hide before undergoing the post-tanning treatment C, as is obvious, is much lower than the initial weight (w).

The method 1 according to the present invention thus comprises at least one first treatment of re-tanning, dyeing and fattening (C.2), which includes:
C.211 feeding water into the drum, at a temperature ranging between about 20° C. and about 40° C., optionally equal to about 30° C., in a percentage ranging between about 120% and 180% by weight with respect to the initial weight (w1) of the hide, optionally equal to about 150% by weight;
C.212 feeding sodium bicarbonate into the drum, in a percentage ranging between about 0.3% and about 0.7% by weight with respect to the initial weight (w1) of the hide, optionally equal to about 0.5% by weight;
C.213 feeding sulphonic acid into the drum, in a percentage ranging between about 1% and 3% by weight with respect to the initial weight (w1) of the hide, optionally equal to about 2% by weight; and
C.214 moving the drum for a time period of at least about 30 min, optionally approximately 40 min at the above mentioned operating speed.
In this step of the first treatment, the hide is expected to have a pH comprised between about 5 and about 5.4, optionally equal to 5.2.

Then the first treatment C.2 comprises:
C.215 feeding sulphonic acid into the drum, in a percentage ranging between about 3% and 5% by weight with respect to the initial weight (w1) of the hide, optionally equal to about 4% by weight;
C.216 feeding acetic acid into the drum, in a percentage ranging between about 3% and 5% by weight with respect to the initial weight (w1) of the hide, optionally equal to about 4% by weight;
C.217 feeding formic acid into the drum, in a percentage ranging between about 3% and 5% by weight with respect to the initial weight (w1) of the hide, optionally equal to about 4% by weight;
C.218 feeding a filler into the drum, optionally one flour, in a percentage ranging between about 3% and 5% by weight with respect to the initial weight (w1) of the hide, optionally equal to about 4% by weight;
C.219 feeding Tara extract into the drum, in a percentage ranging between about 3% and 5% by weight with respect to the initial weight (w1) of the hide, optionally equal to about 4% by weight;
C.220 feeding cationic surfactants into the drum, in a percentage ranging between about 1% and 5% by weight with respect to the initial weight (w1) of the hide, optionally equal to about 3% by weight;
C.221 feeding a dye into the drum, optionally a coloured pigment, optionally white, in a percentage ranging between about 1% and 2% by weight with respect to the initial weight (w1) of the hide, optionally equal to about 1.5% by weight, or a metal free aniline, in a percentage that is a function of the initial weight (w1) of the hide and the intensity of the colour of the hide which is to be obtained;
C.222 feeding lecithin into the drum, in a percentage ranging between about 1% and 3% by weight, with respect to the initial weight (w1) of the hide, optionally equal to about 2% by weight; and
C.223 moving the drum for a time period of at least about 40 min, optionally approximately 60 min at the above mentioned operating speed.

Then, the first treatment C.2 comprises:
C.224 feeding sulphonic acid into the drum, in a percentage ranging between about 3% and 5% by weight with respect to the initial weight (w1) of the hide, optionally equal to about 4% by weight;
C.225 feeding acetic acid into the drum, in a percentage ranging between about 3% and 5% by weight with respect to the initial weight (w1) of the hide, optionally equal to about 4% by weight;
C.226 feeding formic acid into the drum, in a percentage ranging between about 3% and 5% by weight with respect to the initial weight (w1) of the hide, optionally equal to about 4% by weight;
C.227 feeding a filler into the drum, optionally some flour, in a percentage ranging between about 3% and 5% by weight with respect to the initial weight (w1) of the hide, optionally equal to about 4% by weight;
C.228 feeding Tara extract into the drum, in a percentage ranging between about 3% and 5% by weight with respect to the initial weight (w1) of the hide, optionally equal to about 4% by weight; and
C.229 moving the drum for a time period of at least about 40 min, optionally approximately 60 min at said operating speed.
At the end of step C.229, the treatment comprises:
C.230 moving said drum for a maintaining period comprised between about 10 and about 16 hours, optionally approximately 14 hours at a second maintaining speed, which optionally comprises moving said drum for 5 minutes at a speed of about 1 revolution per min and stopping said drum for the next 25 minutes.

The method 1 according to the present invention comprises at least one second treatment of dyeing and fattening (C.4), following the first treatment C.2, comprising:
C.411 feeding water into the drum, at a temperature ranging between about 40° C. and 60° C., optionally equal to about 50° C., in a percentage ranging between about 120% and 180% by weight with respect to the initial weight (w1) of the hide, optionally equal to about 150% by weight;
C.412 feeding a dye into the drum, optionally a coloured pigment, optionally white, in a percentage ranging between about 1% and 2% by weight with respect to the initial weight (w1) of the hide, optionally equal to about 1.5% by weight, or a metal free aniline, in a percentage that is a function of the initial weight (w1) of the hide and the intensity of the colour of the hide which is to be obtained;
C.413 feeding cationic surfactants into the drum, in a percentage ranging between about 4% and 8% by weight with respect to the initial weight (w1) of the hide, optionally equal to about 6% by weight;
C.414 feeding lecithin into the drum, in a percentage ranging between about 4% and 8% by weight, with respect to the initial weight (w1) of the hide, optionally equal to about 6% by weight;
C.415 feeding sodium glutamate into the drum, in a percentage ranging between about 4% and 6% by weight with respect to the initial weight w1 of the hide, optionally equal to about 5% by weight;
C.416 feeding Marseille soap into the drum, in a percentage ranging between about 0.3% and about 0.7% by weight with respect to the initial weight (w1) of the hide, optionally equal to about 0.5% by weight; and
C.417 moving said drum for a time period of at least about 40 min, optionally approximately 60 min at said operating speed.
Then, the second treatment C.4 continues with step:
C.418 feeding formic acid into the drum, in a percentage ranging between about 1% and 3% by weight with respect to the initial weight (w1) of the hide, optionally equal to about 2% by weight; and
C.419 moving said drum for a time period of at least about 70 min, optionally approximately 90 min at said operating speed.

According to a variation of the method of the present invention, between the first treatment C.2 and the second treatment C.4 the method 1 comprises one optional fixing treatment (C.3), comprising:
C.311 feeding water into the drum, at a temperature ranging between about 40° C. and 60° C., optionally equal to about 50° C., in a percentage ranging between about 180% and 220% by weight with respect to the initial weight (w1) of the hide, optionally equal to about 200% by weight;
C.312 feeding formic acid into the drum, in a percentage ranging between about 0.5% and 1.5% by weight with respect to the initial weight (w1) of the hide, optionally equal to about 1% by weight; and
C.313 moving said drum for a time period of at least about 20 min, optionally approximately 30 min at the above mentioned operating speed; then
C.314 feeding formic acid into the drum, in a percentage ranging between about 0.5% and 1.5% by weight with respect to the initial weight (w1) of the hide, optionally equal to about 1% by weight; and
C.315 moving the drum for a time period of at least about 40 min, optionally approximately 60 min at the above mentioned operating speed.

At the end of the fixing treatment C.3, the hide is expected to have a sectional pH comprised between about 3.8 and about 4.2, optionally equal to 4.

At the end of the second treatment C.4 of the post-tanning treatment C, the method comprises one further fixing treatment (C.5), including:
C.511 feeding water into the drum, at a temperature ranging between about 10° C. and 30° C., optionally equal to about 20° C., in a percentage ranging between about 180% and 220% by weight with respect to the initial weight (w1) of the hide, optionally equal to about 200% by weight;
C.512 feeding citric acid into the drum, in a percentage ranging between about 0.5% and 1.5% by weight with respect to the initial weight (w1) of the hide, optionally equal to about 1% by weight; and
C.513 moving said drum for a time period of at least about 10 min, optionally approximately 20 min at said operating speed.

Finally, the method 1 according to the present invention, immediately prior to the implementation of the first post-tanning (C) treatment C.2, comprises one washing treatment C.1, for eliminating any possible residues of metal which can be deposited on the tanned hide after the trimming step, which is performed with metal blades.

That washing C.1 is executed according to the following steps:
C.111 feeding water into the drum, at a temperature ranging between about 10° C. and 30° C., optionally equal to about 20° C., in a percentage ranging between about 180% and 220% by weight with respect to the initial weight (w1) of the hide, optionally equal to about 200% by weight;
C.112 feeding a chelating substance into the drum, in a percentage ranging between about 0.3% and 0.7% by weight with respect to the initial weight (w1) of the hide, optionally equal to about 0.5% by weight;
C.113 feeding oxalic acid into the drum, in a percentage ranging between about 0.1% and 0.5% by weight with respect to the initial weight (w1) of the hide, optionally equal to about 0.3% by weight; and
C.114 moving said drum for a time period of at least about 30 min, optionally approximately 40 min at the above mentioned operating speed.

At the end of the washing treatment C.1, the hide is expected to have a pH comprised between about 4 and about 5, optionally equal to 4.5.

Optionally, after the execution of the second treatment C.4 and, if executed, even after the fixing treatment C.5, the method 1 of the present invention comprises one further washing treatment C.6 of the hide contained into the drum, in order to eliminate from the hide any residues of metal (for example iron), which may be into the treatment liquid, if for example the used water contains traces of iron, or that may derive from the metal components which make up the drum.

That further washing treatment C.6 comprises:
C.611 feeding water into the drum, at a temperature ranging between about 10° C. and 30° C., optionally equal to about 20° C., in a percentage ranging between about 180% and 220% by weight with respect to the initial weight (w1) of the hide, optionally equal to about 200% by weight;
C.612 feeding a chelating substance into the drum, in a percentage ranging between about 0.5% and 1.5% by weight with respect to the initial weight (w1) of the hide, optionally equal to about 1% by weight; and
C.613 moving the drum for a time period of at least about 5 min, optionally approximately 10 min at the above mentioned operating speed.

At the end of steps C.1, C.3, C.4, C.5 and C.6, when executed, the method comprises one draining and washing step C.00 that includes:
draining, with the stationary drum, the liquid therein contained;
feeding water into the drum, at a temperature ranging between about 10° C. and 30° C., optionally equal to about 20° C., in a percentage ranging between about 180% and 220% by weight with respect to the initial weight (w1) of the hide, optionally equal to about 200% by weight;
moving the drum for a time period of at least about 5 min, optionally approximately 10 min at the above mentioned operating speed; and
draining again the liquid contained in the drum.

At the end of the post-tanning treatment, the processed hide has the desired characteristics for the subsequent processing.

With the tanning process described above the problems represented in the introduction are solved.

The hide is, in fact, processed without the use of heavy metals and maintains high performance in terms of softness and lightness, elasticity, resistance to tearing and ease of disposal, in so far as it is biodegradable.

Some preliminary lab testing, carried out on samples of hide processed according to the tanning method 1 described above make it possible, in fact, to recognise how the obtained hide is “green”. The summary table of FIG. 5 allows appreciating, in fact, the responsiveness of three samples of hide tanned according to the method of the present invention, to the rules of law concerning “eco-leather”.

Not only that, laboratory tests carried out on hide processed according to the method described above have also demonstrated the high degree of “biodegradability” of that hide.

In this respect, it is specified that for “biodegradability” it is intended the ability of a material to be converted into CO₂ and H₂O by the action of micro-organisms. Among the various methods proposed in the literature for the determination of the biodegradability of the materials, in the present case the method contained into the ISO 14855 was used, which uses a closed system to capture the CO₂ generated by the degradation of a tested material under conditions of controlled composting.

In the performed laboratory tests, the aerobic biodegradation of one sample of skin “TYPE 1” under conditions of controlled composting was evaluated. Specifically, in the laboratory a process of aerobic composting in reactors of 500 mL was simulated, where the sample to be tested (10 g) was mixed with mature compost (4 months) coming from a composting plant and subsequently incubated at a temperature of 60° C.

In order to be defined “biodegradable”, the level of minimum biodegradation of one material must be equal to 90% in less than 6 months. Experimental errors in measurement make it difficult to achieve 100% and for this reason the threshold of acceptability is fixed at 90% and not at 100%.

With regard to the specifications of the carried out tests, a first sample of skin TYPE 1 was taken which was triturated (SAMPLE A) while another sample of skin TYPE 1 was cut into disks with a diameter of about 8.5 cm (SAMPLE B). The cellulose was considered as reference material. The test lasted 90 days and three replicates were performed. The material in the reactors was mixed every 2/3 days. Each value reported in FIGS. 6a and 6b is the average calculated over the three replications.

It was found that the degradation of the reference material after 45 days was greater than 70% and that the difference between the percentage of biodegradation of the reference material (cellulose) at the end of the probationary period was less than 20%.

It could therefore be concluded that the material being tested (TYPE 1), showed an aerobic biodegradation under conditions of controlled composting of 77.2% in 90 days (SAMPLE A). The value of biodegradability remained almost unchanged even by incubating the disks of the material in question (SAMPLE B), with value of biodegradability of 76.1%. At the end of this incubation period, the disks could not be distinguished from the substrate of incubation.

In the foregoing the preferred embodiments were described and some modifications of the present invention were suggested, but it should be understood that those skilled in the art can make modifications and changes without departing from the relative scope of protection, as defined by the appended claims.

Thus, for example, the tanning method 1 described above includes frequent measurement steps of the pH of the treatment liquid contained into the drum and the sectional pH of the hide (measured i.e. by sectioning the hide at a certain depth), as well as controls on the absorption by the hide of the treatment liquid.

Clearly, in fact, where the pH of the hide should differ with respect to a corresponding range of desired values (see the ranges indicated above), the tanning method 1 according to the present invention comprises to prolong-reduce, in an entirely known way to the person skilled in the art and without anything to invent, the dwell times of the hide into the corresponding treatment liquid and/or increase-decrease the speed of movement of the drum wherein the hide is contained and/or increase-decrease the quantity of chemical components to be fed into the drum at the corresponding treatment step, so that the (sectional) pH of the hide at the end of the corresponding treatment, is comprised in the range of desired values.

1. A method for metal-free tanning of a quantity of hide having initial weight w, said quantity of hide being contained in a drum, wherein said method comprises at least one tanning treatment B of said hide including at least the following operating steps:
B.1 feeding aliphatic aldehyde into said drum, in a percentage ranging between about 1% and 3% by weight with respect to the initial weight w of said hide, optionally equal to about 2% by weight, and
B.2 moving said drum for a time period of at least about 10 min, optionally approximately 20 min at an operating speed between 1 and 8 revolutions/minute, preferably comprised between 4 and 5 revolutions/minute;
B.3 feeding citric acid into said drum, in a percentage ranging between about 0.1% and 0.3% by weight with respect to the initial weight w of said hide, optionally equal to about 0.2% by weight, and
B.4 moving said drum for a time period of at least about other 10 min, optionally approximately 20 min at said operating speed;
B.5 feeding aliphatic aldehyde into said drum, in a percentage ranging between about 1% and about 3% by weight with respect to the initial weight w of said hide, optionally equal to about 2% by weight, and
B.6 moving said drum for a time period of at least about 150 min, optionally approximately 180 min at said operating speed;
B.7 feeding sodium formate into said drum, in a percentage ranging between about 0.3% and about 0.7% by weight with respect to the initial weight w of said hide, optionally equal to about 0.5% by weight, and
B.8 moving said drum for a time period of at least about 20 min, optionally approximately 30 min at said operating speed;
B.9 feeding magnesium oxide into said drum, in a percentage ranging between about 0.3% and about 0.7% by weight with respect to the initial weight w of said hide, optionally equal to about 0.5% by weight, and
B.10 moving said drum for a time period of at least about 60 min, optionally approximately 90 min at said operating speed;
B.11 feeding water into said drum, at a temperature ranging between about 30° C. and about 60° C., optionally equal to about 50° C., in a percentage ranging between about 30% and 50% by weight with respect to the initial weight w of said hide, optionally equal to about 40% by weight, and
B.12 moving said drum for a time period of at least about 100 min, optionally approximately 120 min at said operating speed;
B.13 feeding aliphatic aldehyde into said drum, in a percentage ranging between about 1% and 5% by weight with respect to the initial weight w of said hide, optionally equal to about 3% by weight, and
B.14 moving said drum for a time period of at least about 100 min, optionally approximately 120 min at said operating speed; and then
B.15 moving said drum for a maintaining period comprised between about 10 and about 16 hours, optionally approximately 14 hours, at a first maintaining speed ranging between about 1 and 5 revolutions/hour, optionally comprised between 2 and 4 revolutions/hour, even more optionally equal to about 3 revolutions/hour.

2. The method according to claim 1, wherein after said step B.15 said method comprises at least one step B.16 to remove metal residues, comprising:
B.161 feeding water into said drum, at a temperature ranging between about 10° C. and about 30° C., optionally equal to about 20° C., in a percentage ranging between about 180% and 250% by weight with respect to the initial weight w of said hide, optionally equal to about 200% by weight,
B.162 feeding a chelating substance into said drum, in a percentage ranging between about 0.1% and 0.3% by weight with respect to the initial weight w of said hide, optionally equal to about 0.2% by weight; and
B.163 moving said drum for a time period of at least about 10 min, optionally approximately 15 min at said operating speed.

3. The method according to claim 2, in which at the end of said step B.15 and at the end of said step B.16, if performed, said method comprises at least one draining and flushing step B.17 of said skin thereby treated, including:
B.171 draining, at stationary drum, the liquid contained into said drum;
B.172 feeding water into said drum, at a temperature ranging between about 10° C. and about 30° C., optionally equal to about 20° C., in a percentage ranging between about 180% and 220% by weight with respect to the initial weight w of said hide, optionally equal to about 200% by weight;
B.173 moving said drum for a time period of at least about 5 min, optionally approximately 10 min at said operating speed; and
B.174 draining again the liquid contained in said drum.

4. The method according to claim 1, wherein before said tanning treatment B said method comprises at least one pre-tanning treatment A of said hide contained into said drum, including at least one step A.1 of de-calcination and degreasing of said hide to be treated, comprising:
A.111 feeding water into said drum, at a temperature ranging between about 25° C. and about 30° C., optionally equal to about 27° C., in a percentage ranging between about 100% and 150% by weight with respect to the initial weight w of said hide, optionally equal to about 120% by weight;
A.112 feeding Marseilles soap into said drum, in a percentage ranging between about 0.1% and 0.3% by weight with respect to the initial weight of said hide, optionally equal to about 0.2% by weight;
A.113 feeding ammonium sulphate into said drum, in a percentage ranging between about 0.20% and 0.30% by weight with respect to the initial weight w of said hide, optionally equal to about 0.25% by weight;
A.114 moving said drum for a time period of at least about 20 min, optionally approximately 30 min at said operating speed; and
A.115 draining at stationary drum the liquid contained into said drum.

5. The method according to claim 4 wherein said step A.1 of de-calcination and degreasing of said hide to be treated, comprises, subsequently:
A.116 feeding water into said drum, at a temperature ranging between about 25° C. and about 35° C., optionally equal to about 30° C., in a percentage ranging between about 30% and 70% by weight with respect to the initial weight w of said hide, optionally equal to about 50% by weight;
A.117 feeding Marseilles soap into said drum, in a percentage ranging between about 0.05% and 0.15% by weight with respect to the initial weight w of said hide, optionally equal to about 0.1% by weight;
A.118 feeding ammonium hydroxide into said drum, in a percentage ranging between about 0.3% and 0.7% by weight with respect to the initial weight w of said hide, optionally equal to about 0.5% by weight;
A.119 feeding acetic acid into said drum, in a percentage ranging between about 0.3% and 0.7% by weight with respect to the initial weight w of said hide, optionally equal to about 0.5% by weight;
A.120 moving said drum for a time period of at least about 20 min, optionally approximately 30 min at said operating speed;
A.121 feeding again acetic acid into said drum, in a percentage ranging between about 0.3% and 0.7% by weight with respect to the initial weight w of said hide, optionally equal to about 0.5% by weight;
A.122 feeding ammonium acetate into said drum, in a percentage ranging between about 0.5% and 1.5% by weight with respect to the initial weight w of said hide, optionally equal to about 1% by weight;
A.123 moving said drum for a time period of at least about 150 min, optionally approximately 180 min at said operating speed; and
A.124 draining at stationary drum the liquid contained into said drum.

6. Methods according to claim 5, wherein between said step A.115 and said step A.116 at least one step of the bleaching of said skin is included, comprising:
A.125 feeding water into said drum, at a temperature ranging between about 25° C. and about 35° C., optionally equal to about 30° C., in a percentage ranging between about 100% and 150% by weight with respect to the initial weight w of said hide, optionally equal to about 120% by weight;
A.126 feeding hydrogen peroxide into said drum, in a percentage ranging between about 0.3% and 0.7% by weight with respect to the initial weight w of said hide, optionally equal to about 0.5% by weight;
A.127 moving said drum for a time period of at least about 10 min, optionally approximately 20 min at said operating speed; and
A.128 draining at stationary drum the liquid contained into said drum.

7. The method according to claim 1, wherein before said tanning treatment B and after said step A.1 of de-calcination and degreasing of said hide to be treated, said method comprises at least one maceration treatment A.2 of said hide contained into said drum, including:
A.211 feeding water into said drum, at a temperature ranging between about 30° C. and about 40° C., optionally equal to about 35° C., in a percentage ranging between about 80% and 120% by weight with respect to the initial weight w of said hide, optionally equal to about 100% by weight;
A.212 feeding Marseilles soap into said drum, in a percentage ranging between about 0.05% and 0.15% by weight with respect to the initial weight w of said hide, optionally equal to about 0.1% by weight;
A.213 feeding sheep serum into said drum, in a percentage ranging between about 0.2% and 0.6% by weight with respect to the initial weight w of said hide, optionally equal to about 0.4% by weight;
A.214 moving said drum for a time period of at least about 20 min, optionally approximately 30 min at said operating speed; and then
A.215 draining at stationary drum the liquid contained into said drum, feeding water into said drum at a temperature ranging between about 15° C. and about 25° C., optionally equal to about 20° C., in a percentage ranging between approximately 80% and 120% by weight with respect to the initial weight w of the hide, optionally equal to about 100% by weight, and moving the drum for a time period of at least about 5 min, optionally equal to about 10 min at said operating speed and draining again the liquid contained into the drum.

8. The method according to claim 1, wherein before said tanning treatment B and after said step A.2 of de-calcination and degreasing of said hide to be treated, said method comprises at least one pickling treatment A.3 of said hide contained into said drum, including:
A.311 feeding water into said drum, at a temperature ranging between about 10° C. and about 30° C., optionally equal to about 20° C., in a percentage ranging between about 10% and 30% by weight with respect to the initial weight w of said hide, optionally equal to about 20% by weight;
A.312 feeding industrial salt into said drum, in a percentage ranging between about 4% and 8% by weight with respect to the initial weight w of said hide, optionally equal to about 6% by weight;
A.313 feeding sodium formate into said drum, in a percentage ranging between about 0.3% and 0.7% by weight with respect to the initial weight w of said hide, optionally equal to about 0.5% by weight;
A.314 feeding extra-virgin olive oil into said drum, in a percentage ranging between about 0.5% and 1.5% by weight with respect to the initial weight w of said hide, optionally equal to about 1% by weight, and
A.315 moving said drum for a time period of at least about 10 min, optionally approximately 15 min at said operating speed;
A.316 feeding formic acid into said drum, in a percentage ranging between about 0.6% and 1% by weight with respect to the initial weight w of said hide, optionally equal to about 0.8% by weight, and
A.317 moving said drum for a time period of at least about 20 min, optionally approximately 30 min at said operating speed;
A.318 feeding sulphuric acid into said drum, at a concentration ranging between 40% and 60%, optionally equal to about 50%, in a percentage ranging between about 1% and 1.2% by weight with respect to the initial weight w of said hide, optionally equal to about 1% by weight, and
A.319 moving said drum for a time period of at least about 150 min, optionally approximately 180 min at said operating speed; and
A.320 moving said drum for a maintaining period comprised between about 10 and about 14 hours, optionally approximately 12 hours, at said first maintaining speed.

9. The method according to claim 8, further comprising at least one step A.321 of actuating said drum for a time period of at least about 5 min, optionally approximately 10 min, before said tanning treatment B.

10. The method according to claim 1, wherein after said tanning treatment B at least one post-tanning treatment C of said hide contained in a drum and having initial weight w1, wherein w1<w, is comprised, said post-tanning treatment including at least one first re-tanning, dyeing and fattening treatment C.2, comprising:
C.211 feeding water into said drum, at a temperature ranging between about 20° C. and about 40° C., optionally equal to about 30° C., in a percentage ranging between about 120% and 180% by weight with respect to the initial weight w1 of said hide, optionally equal to about 150% by weight;
C.212 feeding sodium bicarbonate into said drum, in a percentage ranging between about 0.3% and 0.7% by weight with respect to the initial weight w1 of said hide, optionally equal to about 0.5% by weight;
C.213 feeding sulphonic acid into said drum, in a percentage ranging between about 1% and 3% by weight with respect to the initial weight w1 of said hide, optionally equal to about 2% by weight; and
C.214 moving said drum for a time period of at least about 30 min, optionally approximately 40 min at said operating speed; then
C.215 feeding sulphonic acid into said drum, in a percentage ranging between about 3% and 5% by weight with respect to the initial weight w1 of said hide, optionally equal to about 4% by weight;
C.216 feeding acetic acid into said drum, in a percentage ranging between about 3% and 5% by weight with respect to the initial weight w1 of said hide, optionally equal to about 4% by weight;
C.217 feeding formic acid into said drum, in a percentage ranging between about 3% and 5% by weight with respect to the initial weight w1 of said hide, optionally equal to about 4% by weight;
C.218 feeding a filler into said drum, optionally flour, in a percentage ranging between about 3% and 5% by weight with respect to the initial weight w1 of said hide, optionally equal to about 4% by weight;
C.219 feeding Tara extract into said drum, in a percentage ranging between about 3% and 5% by weight with respect to the initial weight w1 of said hide, optionally equal to about 4% by weight;
C.220 feeding cationic surfactants into said drum, in a percentage ranging between about 1% and 5% by weight with respect to the initial weight w1 of said hide, optionally equal to about 3% by weight;
C.221 feeding a dye into said drum, optionally a coloured pigment, optionally white, in a percentage ranging between about 1% and 2% by weight with respect to the initial weight w1 of said hide, optionally equal to about 1.5% by weight, or a metal free aniline, in a percentage that is a function of the initial weight w1 of said hide and the intensity of the colour of said hide which is to be obtained;
C.222 feeding lecithin into said drum, in a percentage ranging between about 1% and 3% by weight, with respect to the initial weight w1 of said hide, optionally equal to about 2% by weight; and
C.223 moving said drum for a time period of at least about 40 min, optionally approximately 60 min at said operating speed; then
C.224 feeding sulphonic acid into said drum, in a percentage ranging between about 3% and 5% by weight with respect to the initial weight w1 of said hide, optionally equal to about 4% by weight;
C.225 feeding acetic acid into said drum, in a percentage ranging between about 3% and 5% by weight with respect to the initial weight w1 of said hide, optionally equal to about 4% by weight;
C.226 feeding formic acid into said drum, in a percentage ranging between about 3% and 5% by weight with respect to the initial weight w1 of said hide, optionally equal to about 4% by weight;
C.227 feeding a filler into said drum, optionally flour, in a percentage ranging between about 3% and 5% by weight with respect to the initial weight w1 of said hide, optionally equal to about 4% by weight;
C.228 feeding Tara extract into said drum, in a percentage ranging between about 3% and 5% by weight with respect to the initial weight w1 of said hide, optionally equal to about 4% by weight;
C.229 moving said drum for a time period of at least about 40 min, optionally approximately 60 min at said operating speed; and
C.230 moving said drum for a maintaining period comprised between about 10 and about 16 hours, optionally approximately 14 hours at a second maintaining speed, which optionally comprises moving said drum for 5 minutes at a speed of about 1 revolution per min and stopping said drum for the next 25 minutes.

11. The method (1) according to claim 10, wherein after said first tanning treatment B at least one more post-tanning treatment C of said hide contained in said drum is comprised, including at least one second dyeing and fattening treatment C.4, comprising:
C.411 feeding water into said drum, at a temperature ranging between about 40° C. and 60° C., optionally equal to about 50° C., in a percentage ranging between about 120% and 180% by weight with respect to the initial weight w1 of said hide, optionally equal to about 150% by weight;
C.412 feeding a dye into said drum, optionally a coloured pigment, optionally white, in a percentage ranging between about 1% and 2% by weight with respect to the initial weight w1 of said hide, optionally equal to about 1.5% by weight, or a metal free aniline, in a percentage that is a function of the initial weight w1 of said hide and the intensity of the colour of said hide which is to be obtained;
C.413 feeding cationic surfactants into said drum, in a percentage ranging between about 4% and 8% by weight with respect to the initial weight w1 of said hide, optionally equal to about 6% by weight;
C.414 feeding lecithin into said drum, in a percentage ranging between about 4% and 8% by weight, with respect to the initial weight w1 of said hide, optionally equal to about 6% by weight;
C.415 feeding sodium glutamate into said drum, in a percentage ranging between about 4% and 6% by weight with respect to the initial weight w1 of said hide, optionally equal to about 5% by weight;
C.416 feeding Marseilles soap into said drum, in a percentage ranging between about 0.3% and 0.7% by weight with respect to the initial weight w1 of said hide, optionally equal to about 0.5% by weight;
C.417 moving said drum for a time period of at least about 40 min, optionally approximately 60 min at said operating speed; then
C.418 feeding formic acid into said drum, in a percentage ranging between about 1% and 3% by weight with respect to the initial weight w1 of said hide, optionally equal to about 2% by weight; and
C.419 moving said drum for a time period of at least about 70 min, optionally approximately 90 min at said operating speed.

12. The method according to claim 11, wherein between said first treatment C.2 and said second treatment C.4 at least one fixing treatment C.3 is comprised, including:
C.311 feeding water into said drum, at a temperature ranging between about 40° C. and 60° C., optionally equal to about 50° C., in a percentage ranging between about 180% and 220% by weight with respect to the initial weight w1 of said hide, optionally equal to about 200% by weight;
C.312 feeding formic acid into said drum, in a percentage ranging between about 0.5% and 1.5% by weight with respect to the initial weight w1 of said hide, optionally equal to about 1% by weight; and
C.313 moving said drum for a time period of at least about 20 min, optionally approximately 30 min at said operating speed; then
C.314 feeding formic acid into said drum, in a percentage ranging between about 0.5% and 1.5% by weight with respect to the initial weight w1 of said hide, optionally equal to about 1% by weight; and
C.315 moving said drum for a time period of at least about 40 min, optionally approximately 60 min at said operating speed.

13. The method according to claim 11, wherein right after said second treatment C.4 at least one further fixing treatment C.5 is comprised, including:
C.511 feeding water into said drum, at a temperature ranging between about 10° C. and 30° C., optionally equal to about 20° C., in a percentage ranging between about 180% and 220% by weight with respect to the initial weight w1 of said hide, optionally equal to about 200% by weight;
C.512 feeding citric acid into said drum, in a percentage ranging between about 0.5% and 1.5% by weight with respect to the initial weight w1 of said hide, optionally equal to about 1% by weight; and
C.513 moving said drum for a time period of at least about 10 min, optionally approximately 20 min at said operating speed.

14. The method according to claim 10, wherein immediately before the execution of said first treatment C.2 said post-tanning treatment comprises at least one washing treatment C.1, including:
C.111 feeding water into said drum, at a temperature ranging between about 10° C. and 30° C., optionally equal to about 20° C., in a percentage ranging between about 180% and 220% by weight with respect to the initial weight w1 of said hide, optionally equal to about 200% by weight;
C.112 feeding a chelating substance into said drum, in a percentage ranging between about 0.3% and 0.7% by weight with respect to the initial weight w1 of said hide, optionally equal to about 0.5% by weight;
C.113 feeding oxalic acid into said drum, in a percentage ranging between about 0.1% and 0.5% by weight with respect to the initial weight w1 of said hide, optionally equal to about 0.3% by weight; and
C.114 moving said drum for a time period of at least about 30 min, optionally approximately 40 min at said operating speed.

15. The method according to claim 11, wherein after the execution of said second treatment C.4, optionally after said further fixing treatment C.5, said post-tanning treatment C comprises at least one further washing treatment C.6, including:
C.611 feeding water into said drum, at a temperature ranging between about 10° C. and 30° C., optionally equal to about 20° C., in a percentage ranging between about 180% and 220% by weight with respect to the initial weight w1 of said hide, optionally equal to about 200% by weight;
C.612 feeding a chelating substance into said drum, in a percentage ranging between about 0.5% and 1.5% by weight with respect to the initial weight w1 of said hide, optionally equal to about 1% by weight; and
C.613 moving said drum for a time period of at least about 5 min, optionally approximately 10 min at said operating speed.

16. The method according to claim 11, wherein at the end of said steps C.1, C.3, C.4, C.5 and C.6, when performed, said method comprises at least one step C.00 including:
draining, at stationary drum, the liquid contained into said drum;
feeding water into said drum, at a temperature ranging between about 10° C. and 30° C., optionally equal to about 20° C., in a percentage ranging between about 180% and 220% by weight with respect to the initial weight w1 of said hide, optionally equal to about 200% by weight;
moving said drum for a time period of at least about 5 min, optionally approximately 10 min at said operating speed; and
draining again the liquid contained in said drum.
